(19) United States
(12) Patent Application Publication
(10) Pub. No.: US 2026/0243299 A1
(43) Pub. Date: Aug. 20, 2026

(54) METHOD FOR DETERMINING DETERIORATION IN FOIL BEARING

(71) Applicant: MITSUBISHI HEAVY INDUSTRIES ENGINE & TURBOCHARGER, LTD., Sagamihara-shi, Kanagawa (JP)

(72) Inventors: Takaya FUTAE, Tokyo (JP); Takuya ARAKAWA, Tokyo (JP); Naruhito HARADA, Tokyo (JP); Takuma ONOGI, Sagamihara-shi (JP); Akihiro SUGIYAMA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/159,855

(22) PCT Filed: Mar. 23, 2023
(86) PCT No.: PCT/JP2023/011548

§ 371 Date: Aug. 26, 2025

(51) Int. Cl. F16C 17/24; F16C 17/02

(52) U.S. Cl. CPC F16C 17/246; F16C 17/024; F16C 2233/00; F16C 2360/24

(57) ABSTRACT

This method for determining deterioration in a foil bearing that supports a rotor shaft of an electric compressor device comprises: a torque under determination acquisition step for acquiring a torque under determination, which is the torque of the rotor shaft at a startup time or a stopping time; a torque determination step for determining whether the torque under determination is less than or equal to a torque threshold value; and a deterioration determination step for determining that the foil bearing has deteriorated when it has been determined that the torque under determination is less than or equal to the torque threshold value.

### TECHNICAL FIELD

The present disclosure relates to a method for determining deterioration of a foil bearing that supports a rotor shaft of an electric compressor device.

### BACKGROUND ART

In the related art, there is known a device for determining the degree of deterioration of a foil bearing that supports a rotating shaft. For example, the deterioration diagnosis device disclosed in PTL 1 includes an outer peripheral surface of a rotating body and a sensor provided to face the outer peripheral surface. The sensor is configured to measure the distance to the outer peripheral surface, and the size of the gap between the rotating body and the foil bearing is estimated based on results of sequential measurements by the sensor while the rotating body is rotating.

### CITATION LIST

### Patent Literature

[PTL 1] Japanese Unexamined Patent Application Publication No. 2022-127541

### SUMMARY OF INVENTION

### Technical Problem

With the above estimation method, since error factors such as misalignment of the rotating shaft or vibrations that occur during rotation are reflected in the measurement results of the sensor, there is a likelihood that it becomes difficult to accurately determine whether a foil bearing has deteriorated.

An object of the present disclosure is to provide a method for determining deterioration of a foil bearing that enables accurate determination of whether a foil bearing has deteriorated.

### Solution to Problem

A method for determining deterioration of a foil bearing according to at least one embodiment of the present disclosure is
a method for determining deterioration of a foil bearing that supports a rotor shaft of an electric compressor device, the method including:
a determination target torque acquisition step of acquiring a determination target torque, which is a torque of the rotor shaft at a time of start-up or stop;
a torque determination step of determining whether the determination target torque is equal to or less than a torque threshold value; and
a deterioration determination step of determining that the foil bearing has deteriorated when it is determined that the determination target torque is equal to or less than the torque threshold value.

### Advantageous Effects of Invention

According to the present disclosure, it is possible to provide a method for determining deterioration of a foil bearing that enables accurate determination of whether a foil bearing has deteriorated.

### BRIEF DESCRIPTION OF DRAWINGS

FIG. 1 is a schematic cross-sectional view of a turbocharger device according to an embodiment.

FIG. 2 is a schematic cross-sectional view of a foil bearing according to an embodiment.

FIG. 3 is a schematic cross-sectional view of a foil bearing that has undergone aging deterioration according to an embodiment.

FIG. 4 is a schematic graph showing a relationship between a gap radial length and a starting torque of a rotor shaft.

FIG. 5 is a schematic graph showing a relationship between a gap radial length and a starting torque in a plurality of turbocharger devices.

FIG. 6 is a flowchart showing an example of a method for determining deterioration of a foil bearing according to a first embodiment.

FIG. 7 is a schematic graph showing changes over time in a rotation speed of a rotor shaft and changes over time in output torque.

FIG. 8 is a schematic graph showing a relationship between a gap radial length and a starting output torque in a plurality of turbocharger devices.

FIG. 9 is a flowchart showing an example of a method for determining deterioration of a foil bearing according to a second embodiment.

### DESCRIPTION OF EMBODIMENTS

Hereinafter, several embodiments of the present disclosure will be described with reference to the accompanying drawings. Dimensions, materials, shapes, relative arrangements, and the like of components described as embodiments or shown in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, expressions such as “being provided with”, “including”, or “having” one component are not exclusive expressions excluding existence of other components.
The same configurations are denoted by the same reference numerals, and the description thereof may be omitted.

### <Overall Configuration of Turbocharger Device 1>

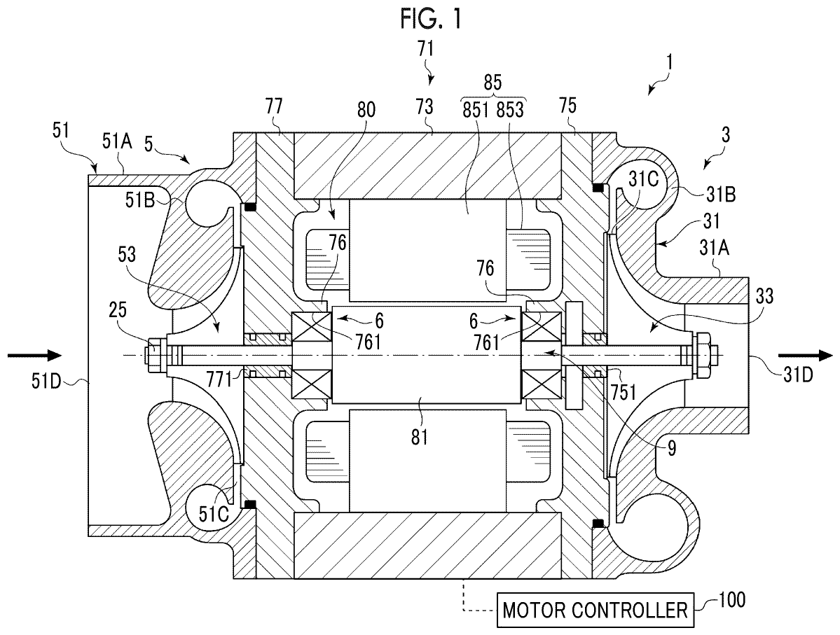

An electric turbocharger device (hereinafter, referred to as a turbocharger device 1) will be described as an example of an electric compressor device according to the present disclosure. FIG. 1 is a schematic cross-sectional view of a turbocharger device 1 according to an embodiment of the present disclosure. The turbocharger device 1 is mounted on, for example, an engine for an automobile. The turbocharger device 1 includes a turbine 3 that rotates upon receiving the flow of exhaust gas, a compressor 5 that takes in air by the rotation of the turbine 3 and that compresses the air, and a motor unit 80 that assists the rotation of the compressor 5.

The turbine 3 includes a turbine housing 31 and a turbine impeller 33 rotatably housed in the turbine housing 31, and the compressor 5 includes a compressor housing 51 and a compressor impeller 53 rotatably housed in the compressor housing 51. The turbine impeller 33 and the compressor impeller 53 are connected via a rotor shaft 9 which is a component of the turbocharger device 1.

Each of the turbine housing 31 and the compressor housing 51 is fixed to a bearing housing 71 which houses a pair of foil bearings 6, which will be described later. The turbine impeller 33 is rotated, for example, by exhaust gas discharged from an engine of an automobile, and accordingly the compressor impeller 53 is rotated via the rotor shaft 9, thereby compressing the intake air supplied to the engine for an automobile.

The turbine housing 31 of the present example includes a cylindrical portion 31A that houses the turbine impeller 33, and a scroll portion 31B that surrounds the portion of the cylindrical portion 31A on the bearing housing 71 side. The scroll portion 31B has an inlet for exhaust gas (not shown) and is in communication with the cylindrical portion 31A via a throat portion 31C. An opening of the cylindrical portion 31A on the opposite side to the bearing housing 71 is formed as an outlet 31D for exhaust gas.

An end wall 75 of the bearing housing 71 is fitted into an opening of the turbine housing 31 on the bearing housing 71 side. The end wall 75 of the bearing housing 71 is fastened to one end portion of a cylindrical peripheral wall 73 by a fastening member, and constitutes a part of the bearing housing 71. A seal portion 751 is provided in a through-hole of the end wall 75, and the rotor shaft 9 is inserted through the seal portion 751.

The compressor housing 51 of the present example includes a cylindrical portion 51A that houses the compressor impeller 53, and a scroll portion 51B that surrounds the portion of the cylindrical portion 51A on the bearing housing 71 side. The scroll portion 51B has an outlet for supply air (not shown), and is in communication with the cylindrical portion 51A via a diffuser portion 51C. An opening of the cylindrical portion 51A on the opposite side to the bearing housing 71 is formed as an inlet 51D for air supply.

An end wall 77 of the bearing housing 71 is fitted into an opening of the compressor housing 51 on the bearing housing 71 side. The end wall 77 of the bearing housing 71 is fastened to the other end portion of the peripheral wall 73 by the fastening member, and constitutes a part of the bearing housing 71. A seal portion 771 is provided in a through-hole of the end wall 77, and the rotor shaft 9 is inserted through the seal portion 771.

A pair of bearing portions 76 are provided on each of the end walls 75 and 77, and a bearing hole 761 is formed in each of the pair of bearing portions 76. A pair of foil bearings 6 serving as radial bearings are disposed in each of the pair of bearing holes 761. The pair of foil bearings 6 rotatably support the rotor shaft 9.

The motor unit 80 includes a rotor portion 81 provided on the rotor shaft 9 between the pair of foil bearings 6, and a stator portion 85 facing the rotor portion 81. The rotor portion 81 has a permanent magnet and a rotor core that supports the permanent magnet, and the stator portion 85 has a stator core 851 supported by the peripheral wall 73 and a stator coil 853 provided on the stator core 851. In the present example, a rotating magnetic field is generated by current flowing through the stator coil 853, and a rotational force acts on the permanent magnets of the rotor portion 81. The motor unit 80 can assist the rotor shaft 9 in rotating by the rotational force.

The energization control of the stator coil 853 is executed by a motor controller 100 that is a component of the turbocharger device 1. The motor controller 100 is configured by a computer, and includes a processor, a memory (a storage medium), and an external communication interface. The processor is a CPU, a GPU, an MPU, a DSP, or a combination of these. The processor of other embodiments may be realized by an integrated circuit such as a PLD, an ASIC, an FPGA, or an MCU. The memory is configured to temporarily or non-temporarily store various types of data, and is realized by, for example, at least one of a RAM, a ROM, or a flash memory. A motor driver for controlling the motor unit 80 is mounted in the motor controller 100 of the present example.

### <Foil Bearing 6>

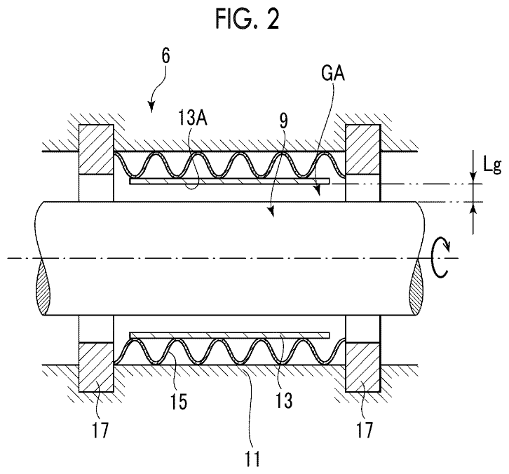

FIG. 2 is a schematic cross-sectional view of the foil bearing 6 according to an embodiment of the present disclosure. Each foil bearing 6 includes a housing 11, a back spring 15, a top foil 13, and a pair of snap rings 17.

The housing 11 is formed inside the above-described bearing portion 76 (see FIG. 1). The back spring 15 is provided inside the housing 11 to surround the rotor shaft 9. The back spring 15 is elastically deformable in a radial direction of the rotor shaft 9. The top foil 13 is a substantially cylindrical member surrounding the rotor shaft 9 inside the back spring 15. An inner peripheral surface 13A of the top foil 13 is coated with a resin, and the inner peripheral surface 13A is in contact with on outer peripheral surface of the rotor shaft 9 in a state where the turbocharger device 1 is stopped.

The pair of snap rings 17 are arranged side by side with the back spring 15 and the top foil 13 therebetween, and each snap ring 17 is attached to the outer peripheral surface of the rotor shaft 9. The movement of each snap ring 17 in an axial direction of the rotor shaft 9 is restricted by the housing 11. Therefore, the movement of the back spring 15 and the top foil 13 in the axial direction is restricted by the pair of snap rings 17.

An outline of operation of the foil bearing 6 is as follows. When the turbocharger device 1 starts to drive, the rotor shaft 9, which had been stopped, starts to rotate. During the acceleration of the rotor shaft 9, a gas flows between the rotor shaft 9 and the top foil 13. Eventually, the rotor shaft 9 and the top foil 13 are separated from each other by a gas film formed between the rotor shaft 9 and the top foil 13. Thereafter, the rotation speed of the rotor shaft 9 reaches a rated rotation speed, and a steady gap GA is formed between the rotor shaft 9 and the top foil 13. Thereafter, when the turbocharger device 1 starts the drive stopping operation, the rotor shaft 9, which had been rotating at the rated rotation speed, starts to decelerate, and the gas film formed between the rotor shaft 9 and the top foil 13 disappears. After the rotor shaft 9 comes into contact with the top foil 13, the rotor shaft 9 further decelerates and eventually stops.

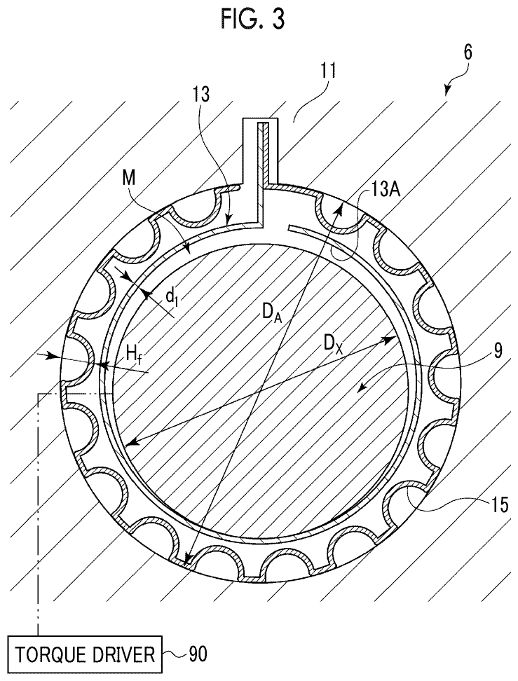

FIG. 3 is a schematic cross-sectional view of the foil bearing 6 that has undergone aging deterioration according to an embodiment of the present disclosure. As a cumulative operating time of the turbocharger device 1 increases, aging deterioration in the foil bearing 6 progresses. More specifically, the inner peripheral surface 13A of the top foil 13 experiences wear, and a gap M occurs between the rotor shaft 9 and the inner peripheral surface 13A even while the turbocharger device 1 is stopped. Furthermore, if a gap radial length, which is the dimension of the gap M in the radial direction of the rotor shaft 9, exceeds an allowable limit value, a failure may occur that makes it difficult to continue operating the turbocharger device 1, such as excessive vibration of the rotor shaft 9 or damage to the foil bearing 6. The allowable limit value of the gap M is smaller than the radial length (a dimension Lg in FIG. 2) of the above-described steady gap GA.

When the gap radial length of the turbocharger device 1 used by a user in the market exceeds the allowable limit value, it is preferable to execute maintenance such as replacing the foil bearing 6 based on the determination that the foil bearing 6 has deteriorated. However, since the degree of progression of wear of the top foil 13 varies depending on the various conditions under which the user uses the turbocharger device 1, it is difficult to accurately determine whether the foil bearing 6 has deteriorated based solely on the cumulative operating time of the turbocharger device 1.

Faced with the above-described problems, the inventors of the present application have found that as the gap radial length increases due to progression of wear of the top foil 13, the area of the outer peripheral surface of the rotor shaft 9 in contact with the top foil 13 decreases, resulting in a decrease in the torque of the rotor shaft 9 at the time of start-up or stop. The inventors of the present application also have found that by determining whether the torque at the time of start-up or stop obtained by measurement is equal to or less than the torque at the allowable limit value of the gap radial length, it is possible to accurately determine whether the foil bearing 6 has deteriorated. Hereinafter, a method for determining deterioration of the foil bearing 6 that the inventors have embodied based on such an idea will be described in two separate embodiments.

A start-up period of the rotor shaft 9 refers to a period from when the stopped rotor shaft 9 starts to rotate until the rotation speed of the rotor shaft 9 reaches the rated rotation speed. In other words, the start-up period of the rotor shaft 9 includes a speed increase period of the rotor shaft 9. In other words, the start-up period of the rotor shaft 9 further includes a period during which the outer peripheral surface of the rotor shaft 9 and the inner peripheral surface 13A of the top foil 13 are in contact with each other. A stop period of the rotor shaft 9 refers to a period from when the rotor shaft 9, which had been rotating at the rated rotation speed, starts to decelerate until the rotor shaft 9 stops. The stop period of the rotor shaft 9 includes a period during which the outer peripheral surface of the rotor shaft 9 and the inner peripheral surface 13A of the top foil 13 are in contact with each other.

### <Method for Determining Deterioration of Foil Bearing 6 According to First Embodiment>

In a first embodiment, whether or not the foil bearing 6 has deteriorated is determined using a starting torque, which is the torque required at the timing when the rotor shaft 9 starts to rotate after being stopped. The starting torque is one specific example of the torque of the rotor shaft 9 at the time of start-up described above, and is measured by an operator who operates a torque driver 90 (see FIG. 3). More specifically, an operator applies a force in a circumferential direction to the rotor shaft 9 via a torque driver 90 connected to the rotor shaft 9 in the stopped state. As the applied force gradually increases, the rotor shaft 9, which had been stopped, eventually starts to rotate. The torque at the moment when the rotor shaft 9 starts to rotate is measured by the torque driver 90 as the starting torque.

The torque driver 90 of the present example measures the starting torque in a state where it is connected to a fastening member 25 (see FIG. 1) that fastens the compressor impeller 53 to the rotor shaft 9. When executing such measurements, a pipe (not shown) connected to the inlet 51D (see FIG. 1) of the turbocharger device 1 may be temporarily removed.

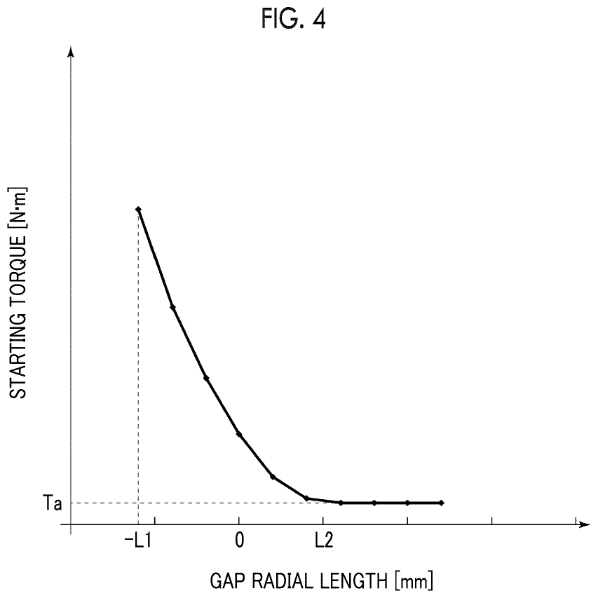

FIG. 4 is a schematic graph showing a relationship between the gap radial length and the starting torque of the rotor shaft 9. The gap radial length indicated by the horizontal axis of the graph is the dimension of the smallest region of the gap M shown in FIG. 3. The horizontal axis range of the graph where the value of the gap radial length is negative indicates a state where not only is the gap M not formed, but the back spring 15 is elastically deformed toward the housing 11 (the negative value of the gap radial length is the amount of deformation of the portion of the back spring 15 that is most elastically deformed). Although the elastic deformation amount of the back spring 15 is a physical quantity (that is, concept) that is strictly different from the radial length of the gap M, if the elastic deformation amount is considered to be included in the gap radial length, the relationship between the gap radial length and the starting torque can be more clearly understood.

In the graph of FIG. 4, in the initial state, which is the state of the turbocharger device 1 where the top foil 13 is considered not to be worn, the gap radial length is −L1 (L1>0). This shows that the gap M is not formed and the elastic deformation amount of the back spring 15 is L1. According to the findings of the inventors, as wear progresses on the inner peripheral surface 13A of the top foil 13, the elastic deformation amount of the back spring 15 gradually decreases, and the gap radial length increases from −L1. Eventually, the elastic deformation of the back spring 15 disappears and the gap radial length becomes zero. As the wear of the inner peripheral surface 13A of the top foil 13 further progresses, the gap M is formed, and the gap radial length becomes a value greater than zero. Then, the gap radial length exceeds L2 which corresponds to the allowable limit value. In the process in which the gap radial length changes from −L1 to L2, the measurement value of the starting torque decreases continuously. In the first embodiment, when the starting torque measured by the torque driver 90 falls below a starting torque (Ta) corresponding to L2 which is an allowable limit value, it is determined that the foil bearing 6 has deteriorated.

Various means can be employed to specify the gap radial length. For example, the gap radial length, L1, is obtained by the following Equation (1).

L1=((D_{A}−(d₁+H_{f})×2)−Dₓ)/2 Equation (1)

In Equation (1), D_{A} is the inner diameter of the housing 11, d₁ is the thickness (radial dimension) of the top foil 13, H_{f} is the radial dimension of the convex portion of the back spring 15 in a free state, and Dₓ is the outer diameter of the rotor shaft 9. These four parameters are illustrated in FIG. 3.

D_{A}, H_{f}, and Dₓ are specified as fixed values (design values), and di is obtained by measurement equipment such as a vernier caliper. Then, the minimum value of di obtained by measurement is substituted into Equation (1) together with D_{A}, H_{f}, and Dₓ, thereby specifying L1.

The graph shown in FIG. 4 shows a relationship between the gap radial length and the starting torque in a single turbocharger device 1. However, the above relationship inevitably varies among a plurality of turbocharger devices 1. Therefore, in the first embodiment, the relationship between the measurement value of the gap radial length and the measurement value of the starting torque is measured for a plurality of turbocharger devices 1, and a more accurate starting torque corresponding to the allowable limit value is obtained.

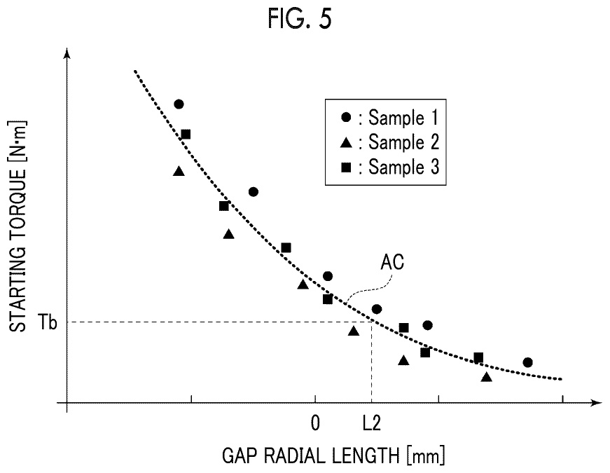

FIG. 5 is a schematic graph showing a relationship between the gap radial length and the starting torque in a plurality of turbocharger devices 1 prepared as samples. In FIG. 5, the measurement values of the gap radial length and the measurement values of the starting torque are illustrated for three turbocharger devices 1 prepared as test samples.

As shown in FIG. 5, the measurement values of the gap radial length measured in each turbocharger device 1 and the measurement values of the starting torque at the timing when the gap radial length is measured are drawn on a single graph, and an approximate curve AC is obtained, for example, by the least squares method. The approximate curve AC is expressed as a function formula. Then, a starting torque (Tb) corresponding to an allowable limit value (L2) already obtained by design calculation before measurement is calculated based on the approximate curve AC. This starting torque is a torque specified based on the results of measurements made in a plurality of turbocharger devices 1, and therefore can be a more accurate threshold value for determining deterioration of the foil bearing 6 (that is, a torque threshold value described below).

For the sake of making the drawing easier to see, the number of samples of the turbocharger device 1 in FIG. 5 is three, but it is preferable to have a larger number of samples. Moreover, it is not essential to draw the measurement results on a graph in order to obtain the approximate curve AC. If the relationship between the measurement values of the gap radial length and the measurement values of the starting torque in a plurality of turbocharger devices 1 is aggregated as measurement results, it is possible to acquire the approximate curve AC as a function formula without drawing a graph.

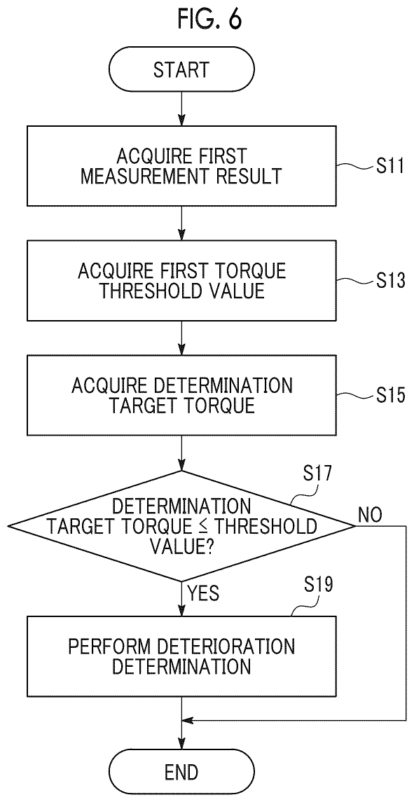

A method for determining deterioration of the foil bearing 6 according to the first embodiment will be described in detail with reference to FIG. 6. FIG. 6 is a flowchart showing an example of a method for determining deterioration of the foil bearing 6 according to the first embodiment. In the following description, “step” may be abbreviated as “S”.

First, a first measurement result acquisition step (S11) is executed to acquire, a relationship between a measurement value of the gap radial length and a measurement value of the starting torque as measurement results collected from a plurality of turbocharger devices 1. In S11 of the present example, in each of a plurality of turbocharger devices 1 prepared as test samples, the gap radial length is measured, and the starting torque when the gap radial length is measured is also measured. After the end of both measurements, the turbocharger device 1 is driven for a certain period of time, and then similar measurements are performed. By alternately repeating the measurement and the driving of the turbocharger device 1, the measurement results such as those shown in FIG. 5 are obtained from a plurality of turbocharger devices 1.

Next, a torque threshold value acquisition step (S13) is executed to acquire a torque threshold value from the measurement results obtained in the first measurement result acquisition step (S11). In S13 of the present example, an operator inputs the measurement results obtained in S11 into a personal computer (PC), and the PC outputs a function formula indicating the approximate curve AC. Then, the operator calculates the starting torque corresponding to the allowable limit value based on the function formula. The calculated starting torque is treated as a torque threshold value. The step of calculating a starting torque based on the function formula and the allowable limit value may be executed by the PC, or may be calculated by an operator using another external computing device.

Next, the starting torque of the rotor shaft 9 of the turbocharger device 1 that is the target of maintenance is acquired as a determination target torque (S15). The turbocharger device 1 that is the target of maintenance is a device different from the test turbocharger device 1 used in S11, and is a device used by users in the market. S15 of the present example is executed by a customer engineer at the timing when the cumulative rotation speed of the rotor shaft 9 of the turbocharger device 1 that is the target of maintenance is estimated to have reached several tens of thousands of rotations. This timing may be a timing when a prescribed period has elapsed since the turbocharger device 1 was delivered to the user, or a timing when the cumulative operating time of the turbocharger device 1 has exceeded a prescribed time. Furthermore, the customer engineer who executes S15 may be the same as the operator who executes S11 and S13, or may be different.

Next, a step of determining whether the determination target torque acquired in S15 is equal to or less than the torque threshold value is executed (S17). S17 is executed by the customer engineer described above. When it is determined that the determination target torque is greater than the torque threshold value (S17:NO), the method for determining deterioration of the foil bearing 6 ends. On the other hand, when it is determined that the determination target torque is equal to or less than the torque threshold value (S17:YES), it is determined that the foil bearing 6 has deteriorated (S19), and then the method for determining deterioration of the foil bearing 6 ends. At this time, the customer engineer continues to execute maintenance such as replacing the foil bearing 6.

According to the above configuration, when it is determined that the determination target torque is equal to or less than the torque threshold value (S17:YES), it is determined that the foil bearing 6 has deteriorated (S19), and therefore it is possible to accurately determine whether the foil bearing 6 has deteriorated. In particular, the starting torque required when the rotor shaft 9 starts to rotate is greater than a running torque required by the rotor shaft 9 after rotation has started, and the amount of change in the starting torque becomes larger as the wear of the top foil 13 of the foil bearing 6 progresses. Therefore, according to the embodiment in which the starting torque is treated as the determination target torque, it is possible to accurately determine whether the foil bearing 6 has deteriorated.

Furthermore, according to a configuration in which the first measurement result acquisition step (S11) and the first torque threshold value acquisition step (S13) are executed, the relationship between the gap radial length and the starting torque is measured in a plurality of turbocharger devices 1. Therefore, the relationship between the gap radial length and the starting torque that is not dependent on unit-to-unit variation of the turbocharger devices 1 can be acquired as the measurement result. Accordingly, the starting torque at the allowable limit value is accurately obtained, and the obtained starting torque is treated as the torque threshold value, so that it is possible to accurately determine whether the foil bearing 6 has deteriorated.

Note that the first embodiment is not limited to the above description. In S11, not only the relationship between the gap radial length and the starting torque is acquired from a plurality of turbocharger devices 1, but also a single turbocharger device 1 after the measurement of the starting torque may be disassembled and reassembled, and the starting torque of the assembled turbocharger device 1 may be measured again. Such a measurement is equivalent to measuring the starting torque from each of two turbocharger devices 1 having the same gap radial length, and can substantially increase the number of samples of measurement results collected in S11. Accordingly, in S13, it is possible to acquire a more accurate starting torque corresponding to the allowable limit value as the torque threshold value.

### <Method for Determining Deterioration of Foil Bearing 6 According to Second Embodiment>

In a second embodiment, it is determined whether the foil bearing 6 has deteriorated based on the output torque output by the rotor shaft 9 during rotation at the time of start-up or stop. The second embodiment differs from the first embodiment in that the torque serving as a reference for determination is not a starting torque, which is classified as a static torque, but an output torque, which is classified as a running torque. As will be described later, the second embodiment also differs from the first embodiment in that the motor controller 100, rather than a customer engineer, determines whether the foil bearing 6 has deteriorated.

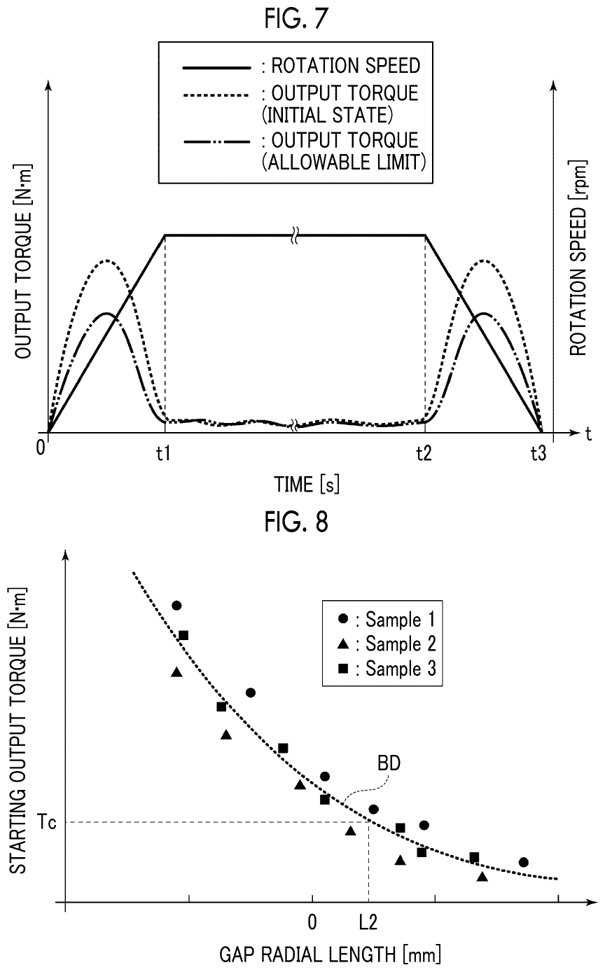

The principle of the determination method according to the second embodiment will be described. FIG. 7 is a schematic graph showing changes over time in the rotation speed of the rotor shaft 9 and changes over time in the output torque. The period from time 0 to t1 is a start-up period of the rotor shaft 9, and the period from time t2 to t3 is a stop period of the rotor shaft 9. In the graph, a solid line indicates the rotation speed of the rotor shaft 9, a dashed line indicates the output torque of the rotor shaft 9 when the turbocharger device 1 is in the initial state, and a dashed double-dotted line indicates the output torque of the rotor shaft 9 when the gap radial length is at the allowable limit value. As can be seen from FIG. 7, in the process in which the top foil 13 experiences wear, the output torque at the time of start-up and stop is continuously reduced. This is because as the wear of the top foil 13 progresses, the area of the outer peripheral surface of the rotor shaft 9 that comes into contact with the top foil 13 decreases.

The output torque is relatively small in the period from time t1 to time t2 in the graph because the rotor shaft 9 separates from the top foil 13 and the running torque required for the rotor shaft 9 to rotate at the rated rotation speed is relatively small. During this period, a value of the current flowing through the stator coil 853 is relatively small.

In the second embodiment, when the output torque measured at the time of start-up or stop is equal to or less than the output torque indicated by the dashed double-dotted line, it is determined that the foil bearing 6 has deteriorated. The output torque to be measured may be either the output torque at the time of start-up of the rotor shaft 9 or the output torque at the time of stop of the rotor shaft 9, but the following illustrates an embodiment in which the output torque at the time of start-up of the rotor shaft 9 is measured. Hereinafter, the output torque at the time of start-up may be referred to as a “starting output torque”.

The measurement of the starting output torque of the rotor shaft 9 is executed through the measurement of the current flowing through the stator coil 853 of the turbocharger device 1. A current flowing through the stator coil 853 is measured by a motor driver mounted in the motor controller 100, and a processor mounted in the motor controller 100 calculates the output torque based on the measurement result. The output torque is calculated using data indicating a relationship between a current value and an output torque. The data may be a function formula indicating a relationship between the current value and the output torque, and is stored in the memory of the motor controller 100. In this case, the processor may simply read the function formula from the memory and use the function formula in the calculation. The starting output torque calculated in this manner can be regarded as a measurement value.

The output torque indicated by the dashed double-dotted line in the graph of FIG. 7 indicates the output torque in a single turbocharger device 1. However, when the gap radial length reaches the allowable limit value, the output torque inevitably varies among the plurality of turbocharger devices 1. Therefore, in the second embodiment, the relationship between the measurement value of the gap radial length and the measurement value of the output torque at the time of start-up is measured for a plurality of turbocharger devices 1, and the starting output torque corresponding to the allowable limit value is more accurately obtained.

FIG. 8 is a schematic graph showing a relationship between the gap radial length and the starting output torque in a plurality of turbocharger devices 1 prepared as samples. In FIG. 8, the measurement values of the gap radial length and the measurement values of the starting output torque are illustrated for three turbocharger devices 1 prepared as test samples.

As shown in FIG. 8, the measurement values of the gap radial length measured in each turbocharger device 1 and the measurement values of the starting output torque are drawn on a single graph, and an approximate curve BD is obtained, for example, by the least squares method. The approximate curve BD is expressed as a function formula. Then, the starting output torque corresponding to an allowable limit value (L2) already obtained as a design value before measurement is calculated based on the approximate curve BD. This starting output torque (Tc) is a torque specified based on the results of measurements made in a plurality of turbocharger devices 1, and therefore can be a more accurate threshold value for determining deterioration of the foil bearing 6 (a torque threshold value).

For the sake of making the drawing easier to see, the number of samples of the turbocharger device 1 in FIG. 8 is three, but it is preferable to have a larger number of samples. Moreover, it is not essential to draw the measurement results on a graph in order to obtain the approximate curve BD. If the relationship between the measurement values of the gap radial length and the measurement values of the starting output torque in a plurality of turbocharger devices 1 is aggregated, it is possible to acquire the approximate curve BD as a function formula without drawing a graph.

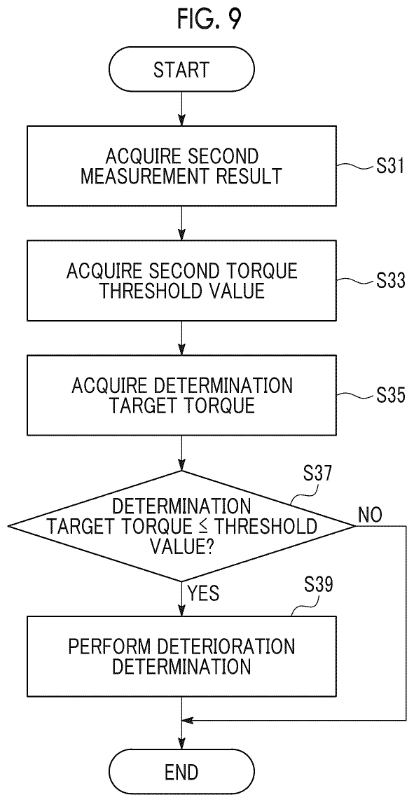

A method for determining deterioration of the foil bearing 6 according to the second embodiment will be described in detail with reference to FIG. 9. FIG. 9 is a flowchart showing an example of a method for determining deterioration of the foil bearing 6 according to the second embodiment.

First, a second measurement result acquisition step (S31) is executed to acquire, a relationship between a measurement value of the gap radial length and a measurement value of the starting output torque as measurement results collected from a plurality of turbocharger devices 1. In S31 of the present example, in each of a plurality of turbocharger devices 1 prepared as test samples, the gap radial length is measured, and the starting output torque when the gap radial length is measured is also measured. The starting output torque is measured, for example, by measuring a value of a peak current flowing through the stator coil 853 during the start-up period. The starting output torque obtained based on the current value and the above-mentioned function formula is output from the motor controller 100 of each turbocharger device 1 to an external computing device such as a personal computer. An operator who operates the external computing device can acquire the starting output torque as a measurement result. After the gap radial length and the starting output torque are measured, the turbocharger device 1 is driven for a certain period of time, and thereafter, the gap radial length and the starting output torque are measured again in the same manner. By alternately repeating the measurement and the driving of the turbocharger device 1, the measurement results such as those shown in FIG. 8 are obtained from a plurality of turbocharger devices 1.

Next, a torque threshold value acquisition step (S33) is executed to acquire a torque threshold value from the measurement results obtained in the second measurement result acquisition step (S31). In S33 of the present example, an operator inputs the measurement results obtained in S31 into a personal computer (PC), and the PC outputs a function formula indicating the approximate curve BD. Then, the operator calculates the starting output torque corresponding to the allowable limit value based on the function formula. The calculated starting output torque is treated as a torque threshold value. The step of calculating an output torque based on the function formula and the allowable limit value may be executed by the PC, or may be calculated by an operator using another external computing device. In the present example, the torque threshold value obtained in S33 is stored in the memory of the motor controller 100 of the turbocharger device 1 that is shipped as a product.

Next, the starting output torque of the rotor shaft 9 of the turbocharger device 1 that is the target of maintenance is acquired as a determination target torque (S35). The turbocharger device 1 that is the target of maintenance is a device different from the test turbocharger device 1 used in S31, and is a device used by users in the market. In the present example, S35 is periodically executed by the controller of the turbocharger device 1 that is the target of maintenance. The method for acquiring the starting output torque to be determined is as described above.

Next, it is determined whether the determination target torque acquired in S35 is equal to or less than the torque threshold value acquired in S33 (S37). In S37 of the present example, the motor controller 100 compares the torque threshold value read from the memory with the determination target torque acquired in S35. When the motor controller 100 determines that the determination target torque is greater than the torque threshold value (S37:NO), the method for determining deterioration of the foil bearing 6 ends. On the other hand, when it is determined that the determination target torque is equal to or less than the torque threshold value (S37:YES), the motor controller 100 determines that the foil bearing 6 has deteriorated (S39), and then the method for determining deterioration of the foil bearing 6 ends. At this time, the motor controller 100 may output a signal indicating that maintenance, such as replacing the foil bearing 6, is necessary to a predetermined external computing device, or may execute a process to forcibly stop the turbocharger device 1.

According to the above configuration, when it is determined that the determination target torque is equal to or less than the torque threshold value (S37:YES), it is determined that the foil bearing 6 has deteriorated (S39), and therefore it is possible to accurately determine whether the foil bearing 6 has deteriorated. In particular, the starting output torque of the rotor shaft 9 has a relatively large peak, and the amount of change in the starting output torque becomes larger as the wear of the top foil 13 of the foil bearing 6 progresses. Therefore, according to the embodiment in which the starting output torque is treated as the determination target torque, it is possible to accurately determine whether the foil bearing 6 has deteriorated.

Furthermore, according to a configuration in which the second measurement result acquisition step (S31) and the second torque threshold value acquisition step (S33) are executed, since the relationship between the gap radial length and the starting output torque is measured in a plurality of turbocharger devices 1, the relationship between the gap radial length and the starting output torque that is not dependent on unit-to-unit variation of the turbocharger devices 1 can be acquired as the measurement result. Accordingly, the starting output torque at the allowable limit value is accurately obtained, and the obtained starting output torque is treated as the torque threshold value, so that it is possible to accurately determine whether the foil bearing 6 has deteriorated.

In the flowchart shown in FIG. 9, an example is given in which the starting output torque is the determination target torque, but the second embodiment is not limited thereto. For example, there is no problem even though the output torque at the time of stop is the determination target torque. The method for acquiring the output torque at the time of stop is similar to the method for acquiring the starting output torque. Similarly to the starting output torque, the output torque at the time of stop also has a relatively large peak (see FIG. 7) and decreases significantly as the wear of the foil bearing 6 progresses. Therefore, even in an embodiment in which the output torque at the time of stop is used as the determination target torque and the torque threshold value, it is possible to accurately determine whether the foil bearing 6 has deteriorated.

### <Other Modification Examples>

In the above description, the embodiments in which the electric compressor device is the turbocharger device 1 have been described, but the present disclosure is not limited thereto. For example, the present disclosure may be applied to an electric compressor that does not include a turbine 3. The electric compressor may be a single-stage electric compressor in which a compressor impeller 53 is provided at only one end of the rotor shaft 9, or a two-stage electric compressor in which a pair of compressor impellers 53 are provided at each of both ends of the rotor shaft 9.

### <Summary>

For example, the contents described in some embodiments described above are understood as follows.

1) A method for determining deterioration of a foil bearing (6) according to at least one embodiment of the present disclosure is
a method for determining deterioration of a foil bearing that supports a rotor shaft of an electric compressor device (turbocharger device 1), the method including:
a determination target torque acquisition step (S15, S35) of acquiring a determination target torque, which is a torque of the rotor shaft at a time of start-up or stop;
a torque determination step (S17, S37) of determining whether the determination target torque is equal to or less than a torque threshold value; and
a deterioration determination step (S19, S39) of determining that the foil bearing has deteriorated when it is determined that the determination target torque is equal to or less than the torque threshold value.

The inventors of the present application have found that as wear of the foil bearing progresses, the determination target torque decreases. According to the above configuration 1), when it is determined that the determination target torque is equal to or less than the torque threshold value, it is determined that the foil bearing has deteriorated, and therefore it is possible to accurately determine whether the foil bearing has deteriorated.

2) In some embodiments, in the method for determining deterioration of a foil bearing described in 1) above, in the determination target torque acquisition step, a measurement value of a starting torque required for the rotor shaft to start rotating at the time of start-up is acquired as the determination target torque.

The starting torque required when the rotor shaft starts to rotate is greater than a running torque required by the rotor shaft after rotation has started, and the amount of change in the starting torque becomes larger as the wear of the foil bearing progresses. According to the above configuration 2), since the starting torque is acquired as the determination target torque, it is possible to accurately determine whether the foil bearing has deteriorated.

3) In some embodiments, the method for determining deterioration of a foil bearing described in 2) above further includes:
a first measurement result acquisition step (S11) of acquiring, before executing the determination target torque acquisition step, a relationship between a measurement value of a dimension of a gap between the foil bearing and the rotor shaft and a measurement value of the starting torque as measurement results collected from a plurality of the electric compressor devices; and
a first torque threshold value acquisition step (S13) of calculating the starting torque corresponding to an allowable limit value of the dimension of the gap from the measurement results obtained in the first measurement result acquisition step, and acquiring the calculated starting torque as the torque threshold value.

According to the above configuration 3), since the relationship between the dimension of the gap and the starting torque is measured for a plurality of electric compressor devices, a relationship between the dimension of the gap and the starting torque that is not dependent on unit-to-unit variation of the electric compressor devices can be acquired as the measurement result. Accordingly, the starting torque at the allowable limit value is accurately obtained, and the obtained starting torque is treated as the torque threshold value, so that it is possible to accurately determine whether the foil bearing has deteriorated.

4) In some embodiments, in the method for determining deterioration of a foil bearing described in 1) above,
in the determination target torque acquisition step, an output torque output by the rotor shaft at the time of start-up or stop is calculated based on a measurement value of a current flowing through the electric compressor device, and the calculated output torque is acquired as the determination target torque.

At the time of start-up or stop, the rotor shaft is in contact with the foil bearing, and the output torque changes significantly depending on whether or not the wear of the foil bearing progresses. According to the above configuration 4), since the output torque is acquired as the determination target torque, it is possible to accurately determine whether the foil bearing has deteriorated.

5) In some embodiments, the method for determining deterioration of a foil bearing described in 4) above further includes:
a second measurement result acquisition step (S31) of acquiring, before executing the determination target torque acquisition step, a relationship between a measurement value of a dimension of a gap between the foil bearing and the rotor shaft and a measurement value of the output torque as measurement results collected from a plurality of the electric compressor devices; and
a second torque threshold value acquisition step (S33) of calculating the output torque corresponding to an allowable limit value of the dimension of the gap from the measurement results obtained in the second measurement result acquisition step, and acquiring the calculated output torque as the torque threshold value.

According to the above configuration 5), since the relationship between the dimension of the gap and the output torque is measured for a plurality of electric compressor devices, a relationship between the dimension of the gap and the output torque that is not dependent on unit-to-unit variation of the electric compressor devices can be acquired as the measurement result. Accordingly, the output torque at the allowable limit value is accurately obtained, and the obtained output torque is treated as the torque threshold value, so that it is possible to accurately determine whether the foil bearing has deteriorated.

### REFERENCE SIGNS LIST

1: turbocharger device
3: turbine
5: compressor
6: foil bearing
9: rotor shaft
11: housing
13: top foil
13A: inner peripheral surface
15: back spring
17: snap ring
25: fastening member
31: turbine housing
33: turbine impeller
51: compressor housing
53: compressor impeller
71: bearing housing
73: peripheral wall
75, 77: end wall
80: motor unit
81: rotor portion
85: stator portion
90: torque driver
100: motor controller
851: stator core
853: stator coil
AC, BD: approximate curve
GA: steady gap
M: gap

1. A method for determining deterioration of a foil bearing that supports a rotor shaft of an electric compressor device, the method comprising:
a determination target torque acquisition step of acquiring a determination target torque, which is a torque of the rotor shaft at a time of start-up or stop;
a torque determination step of determining whether the determination target torque is equal to or less than a torque threshold value; and
a deterioration determination step of determining that the foil bearing has deteriorated when it is determined that the determination target torque is equal to or less than the torque threshold value.

2. The method for determining deterioration of a foil bearing according to claim 1, wherein, in the determination target torque acquisition step, a measurement value of a starting torque required for the rotor shaft to start rotating at the time of start-up is acquired as the determination target torque.

3. The method for determining deterioration of a foil bearing according to claim 2, further comprising:
a first measurement result acquisition step of acquiring, before executing the determination target torque acquisition step, a relationship between a measurement value of a dimension of a gap between the foil bearing and the rotor shaft and a measurement value of the starting torque as measurement results collected from a plurality of the electric compressor devices; and
a first torque threshold value acquisition step of calculating the starting torque corresponding to an allowable limit value of the dimension of the gap from the measurement results obtained in the first measurement result acquisition step, and acquiring the calculated starting torque as the torque threshold value.

4. The method for determining deterioration of a foil bearing according to claim 1, wherein, in the determination target torque acquisition step, an output torque output by the rotor shaft at the time of start-up or stop is calculated based on a measurement value of a current flowing through the electric compressor device, and the calculated output torque is acquired as the determination target torque.

5. The method for determining deterioration of a foil bearing according to claim 4, further comprising:
a second measurement result acquisition step of acquiring, before executing the determination target torque acquisition step, a relationship between a measurement value of a dimension of a gap between the foil bearing and the rotor shaft and a measurement value of the output torque as measurement results collected from a plurality of the electric compressor devices; and
a second torque threshold value acquisition step of calculating the output torque corresponding to an allowable limit value of the dimension of the gap from the measurement results obtained in the second measurement result acquisition step, and acquiring the calculated output torque as the torque threshold value.
